(19) United States
(12) Patent Application Publication
(10) Pub. No.: US 2019/0370731 A1
(43) Pub. Date: Dec. 5, 2019

(54) METHOD TO ANALYZE PERISHABLE FOOD STOCK PREDICTION

(71) Applicant: International Business Machines Corporation, Armonk, NY (US)

(72) Inventors: Marcelo Mota Manhaes, Curitiba (BR); Daniel D.P. Turco, Campinas (BR); Reinaldo Tetsuo Katahira, Jundiai (BR)

(21) Appl. No.: 15/991,470

(22) Filed: May 29, 2018

(51) Int. Cl. G06Q 10/08; G06N 99/00; G06N 5/04; G06Q 30/02

(52) U.S. Cl. CPC G06Q 10/087; G06Q 30/0201; G06N 5/045; G06N 99/005

(57) ABSTRACT

Predicting perishable food stock quantity for replenishment. A search strategy is created for searching at least unstructured data along multiple dimensions based on the user input. A search of a network of computers is performed according to the search strategy. A machine learning model associated with a dimension is invoked, for each of the multiple dimensions. The machine learning model outputs a replenishment quantity along each of the multiple dimensions. The replenishment quantities of the multiple dimensions are merged to provide a predicted suggestion.

### BACKGROUND

The present application relates generally to computers and computer applications, and more particularly to computer artificial intelligence and machine learning models.

It is observed that retailers of perishable foods, from small stores to large supermarket chains, face a challenge in balancing the amounts of the products that need to be purchased from the producers and the quantity of products that will be sold to the final customer before the expiration date is due. This situation may obligate the retailer to put the products on sale, providing expressive discounts to avoid losing the products and minimizing loss. Such scenario can be especially visible in market seasons in supply chain.

### BRIEF SUMMARY

A computer-implemented method and system of predicting perishable food stock quantity for replenishment, for example, via machine learning, may be provided. In one aspect, the method may include receiving a user input comprising at least a product identifier of a product about which a quantity to replenish is to be predicted. The method may further include creating a search strategy comprising searching at least unstructured multiple dimensions of data stored on a network of computers based on the user input. The method may also include performing a search of the network of computers according to the search strategy. The method may further include invoking a machine learning model associated with a dimension, for each of the multiple dimensions, with a result of the search generated into a feature vector as input to the machine learning model. The machine learning model may output a replenishment quantity along each of the multiple dimensions, the output of the machine learning model representing candidate answers. The method may also include selecting supporting evidence associated with the candidate answers. The method may also include merging the candidate answers of the multiple dimensions. The method may further include providing a result of the merged output quantities as a predicted suggestion.

A system of predicting perishable food stock quantity for replenishment, in one aspect, may include at least one hardware processor communicatively coupled to a network of computers, the at least one hardware processor may be operable to receive a user input comprising at least a product identifier of a product about which a quantity to replenish is to be predicted. The at least one hardware processor may be further operable to create a search strategy comprising searching at least unstructured multiple dimensions of data stored on the network of computers based on the user input. The at least one hardware processor may be further operable to perform a search of the network of computers according to the search strategy. The at least one hardware processor may be further operable to invoke a machine learning model associated with a dimension, for each of the multiple dimensions, with a result of the search generated into a feature vector as input to the machine learning model. The machine learning model may output a replenishment quantity along each of the multiple dimensions, the output of the machine learning model representing candidate answers. The at least one hardware processor may be further operable to select a supporting evidence associated with the candidate answers, for example, respective candidate answer. The at least one hardware processor may be further operable to merge the candidate answers of the multiple dimensions. The at least one hardware processor may be further operable to provide a result of the merged output quantities as a predicted suggestion.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates a system context in one embodiment.

FIG. 2 shows a solution model according to one embodiment of a method in the present disclosure.

FIG. 3 is a diagram illustrating a flow of a method of the present disclosure according to one embodiment.

FIG. 4 is a diagram illustrating trained models according to an embodiment.

FIG. 5 shows an example of evidence feature vector in one embodiment.

FIG. 6 is a flow diagram illustrating a computer-implemented process that predicts perishable food stock quantity for replenishment, in one embodiment.

FIG. 7 illustrates a schematic of an example computer or processing system that may implement a system according to one embodiment.

FIG. 8 illustrates workflows of methods in one embodiment.

FIG. 9 illustrates an example of synthesizing multiple responses in one embodiment.

FIG. 10 illustrates feature vector merging and ranking in one embodiment.

FIGS. 11-13 illustrate merging and ranking with respect to an example, in one embodiment.

FIG. 14 illustrates relationship extraction in one embodiment.

### DETAILED DESCRIPTION

A cognitive method, system and techniques may be provided that predict the correct amount of product to buy from the producer along the time duration, e.g., the months of the year, for example, to assist perishable foods retailers to avoid waste and loss. According to some embodiments, the method may gather unstructured data sources based on one or more rules associated with the product segment. The method may analyze using one or more cognitive methods and provide a response comprising the perishable products amount to buy and/or stock, for example, to the user.

In some embodiments, the big data which may provide a rich set of information about customer behavior, sentiment and emotions related to products, geographic behavior, economic news, weather predictions, may be leveraged with cognitive methods to define a decision support to the seller to buy a perishable product amount that minimizes loss. For instance, the method according to some embodiments may use techniques such as the machine learning, information retrieval, semantic web, natural language processing, to gather unstructured content from sources such as the World Wide Web (web) sites and social media platforms or application, in several data dimensions like consumer class, geographic behavior, weather conditions, economy situation and retailer features and establish an evidence score based on the gathered unstructured content. The method may help retailers to buy a perishable product related to predictable consumer demand.

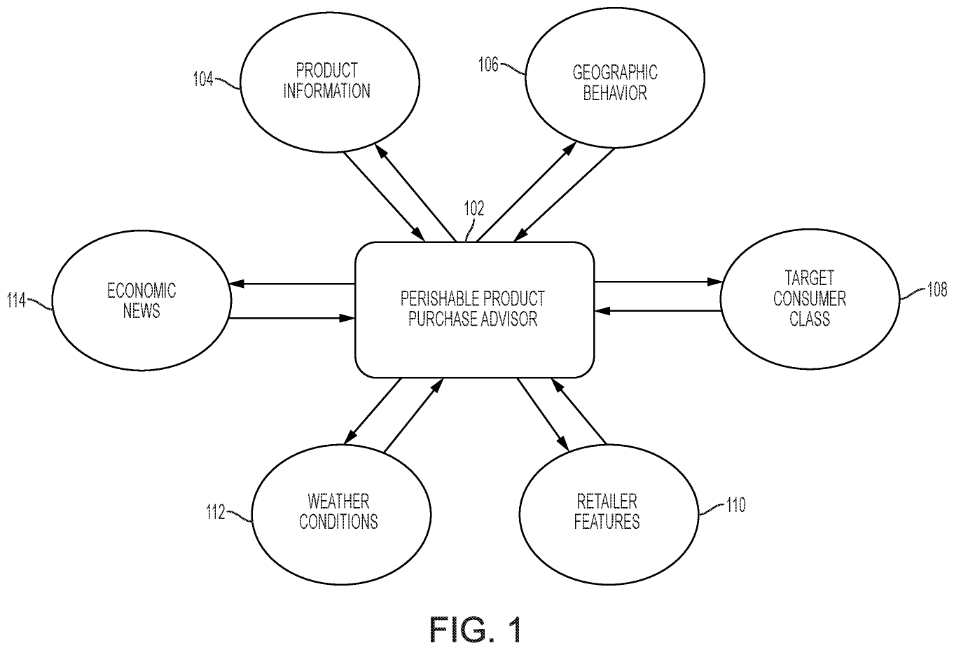

FIG. 1 illustrates a system context in one embodiment. A perishable product purchase advisor 102, for instance, may utilize information obtained from crawling data sources, e.g., shown at 104, 106, 108, 110, 112, 114, to train or tune one or more machine learning models, and provide the ability to have a better understanding of an entire market necessity. The product information data source 104 may include information that can be used to determine the amount that a user wants to buy and the amount of a desired perishable product that exists currently in stock. The geographic behavior data source 106 may include information that can be used to determine the location where the consumer resides, which may tell about the consumer's foods necessities, e.g., including the type and amount of food that is predictable for the consumer to buy. The target consumer class data source 108 may include information that can be used to determine a consumer class, for example, based on the user expressed emotions, sentiments, tones and personalities in a selectable target class. From this type of source, it is possible to retrieve information about the consumers, e.g., including foods preferences and upcoming buying needs. The retailer features data source 110 may include information that can be used to provide a data dimension that is used to define the correct buying strategy. For instance, this feature may aid in determining the desired profit the enterprise needs in a period per a product. One or more features may be input by a user about the retailer to find a best volume to consume. The weather conditions 112 provide weather forecast impact on food that could be consumed. Moreover, the weather can affect the producer to deliver types of foods, for example, if a type of food depends on a specific range of temperature or another weather condition. Taking the weather condition into account, this variable can make a difference when predicting the type and amount of food that could be consumed. The economic news data source 114 may include information that can be used to provide the economy of a region, country and global, which may affect the sales of all types of products, e.g., including perishable foods, and may provide information used to refine the prediction of the consumer behavior. The method in some embodiments leverages data dimensions as well as unstructured data from public web sites and social media applications.

The data source components 104, 106, 108, 110, 112 and 114 may be crawled by functions that feed data, filter relevant data, reduce data, normalize data and/or convert data to a desired data format, to provide to the purchase advisor 102. A search component (referred to herein also as a “primary” search or “primary” search component, only for explanation and clarity sake) or functionality in some embodiments comprises those functions. The primary search component may also include one or more search engines, which search for unstructured text and for structured content. In some embodiments, the primary search component can deliver multiple results for plausible candidates by dimension. In some embodiments, the primary search component which may include crawler functionality, may collect and represent data dimensions of structured and unstructured data directly related by keywords, by ontology and/or by an annotation system fostered by experts. A knowledge base, for example, database storing information, may store ontology and one or more sites the primary search components may crawl for data. An annotation and ontology segmented by a dimension allow for extracting of meaningful data such as passages and/or titles in documents. For example, a primary search component may extract information about a perishable product and/or a brand, guided by information from a knowledge base. For instance, consider that a product being considered is a chocolate, or boxes of chocolate. Feature dimensions such as the following dimensions may be crawled for or extracted from various sites: Brands on this product segment (chocolate); Geographic locations of consumers and market; Social media (e.g., sentiments about brand X or chocolate boxes of people in geography Y); Target consumer class information in location Y in web crawler sites. Information may be extracted also, using a market segmentation approach. For instance, segmentations may include geographic segment (e.g., by locations, climate, region); demographic/socioeconomic segment; psychographic segment (e.g., lifestyles); behavioral segment (e.g., degree of loyalty to product or brand); product-related segment (e.g., relationship to a product such as continuous decrease in consumption by a group); economic news in web sites (e.g., production records by periods, which can increase offerings, decrease prices; weather news (e.g., weather, temperature, which may influence chocolate consumption). In some embodiments, these dimensions may be used to train the machine learning models. A trained machine learning model may be run with new input data and the machine learning model fed with new input data may predict a suggested option for buying the product (e.g., chocolate).

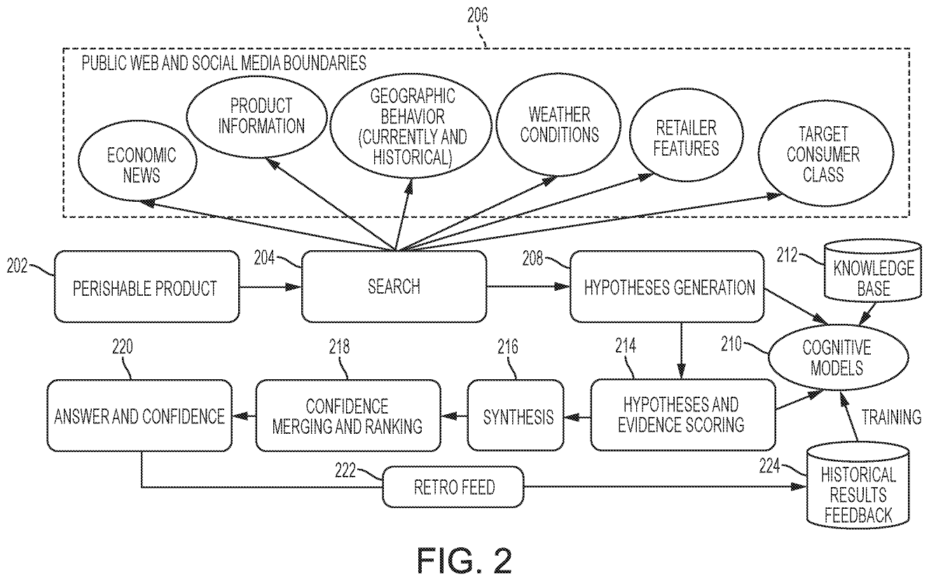

FIG. 2 shows a solution model illustrating a cognitive method that analyzes the feature dimensions shown in FIG. 1 according to one embodiment. The method may be executed on or by at least one hardware processor, for instance, couple with a memory device, and for example, running a user interface that interacts with a user, for example, on a display screen. The method in some embodiments may start at 202 with a question asked about a perishable product, for example, for an advice in buying or stocking the perishable product. For instance, the hardware processor executing the method may receive a question, for example, from a user, which question may be entered via the user interface.

At 204, a search (e.g., referred to as a “primary” search) is performed that searches data on dimensions, for example, on the web, for example, Internet web sites, and social media data sources 206.

At 208, hypotheses may be generated based on searching or crawling the web and social media data source 206. Initial hypotheses may include assumptions generated from the primary search on dimensions, for example, crawled and stored. Hypotheses may be stored in unstructured data such as text. In some embodiments, the output of the primary search may be formatted in JSON (Java Script Object Notation), which may be stored, for example, on a storage device and/or in a temporary cloud resource. The formatted output may be processed by a cognitive model to generate candidate hypothesis. Table 1 illustrates examples of data structures formatted in JSON.

TABLE 1

| Dimension | JSON sample |
|---|---|
| Economic News | { |
| | “HyphothesesId”:“1ec05120-209b-11e8-bb55-dd6da3423163”, |
| | “dimension”:“Economic News” |
| | “sentence”:“The production of cocoa was record in year X in X |
| | location.”, |
| | “source”: “economicworld.com” |
| | } |
| Social Media | { |
| | “HyphothesesId”:“1ec05120-209b-11e8-bb55-dd6da3423173”, |
| | “dimension”:“Social Media” |
| | “sentence”:“Hey James. May I have some opinion about Chocolate |
| | Factory X? they are . . . [literals of example user opinion] .”, |
| | “source”: “instantnews.com” |
| | } |
| Political News | { |
| | “HyphothesesId”:“1ec05120-209b-11e8-bb55-dd6da3423153”, |
| | “dimension”:“Political News” |
| | “sentence”:“[literals of example political news] involving Chocolate |
| | Factory X”, |
| | “source”: “politicnow.com” |
| | } |
| Weather | { |
| Predictions | “HyphothesesId”:“1ec05120-209b-11e8-bb55-dd6da3423143”, |
| | “dimension”:“Weather Prediction” |
| | “sentence”:“The weather prediction for April in Location Y is very |
| | cold”, |
| | “source”: “weatherinsights.com” |
| | } |

At 210, a cognitive model that is built or trained for each data dimension is invoked. In some embodiments, the data obtained in a primary search and formatted into a desired format, e.g., JSON, may be enriched by performing an analysis of the data. An example of this enriching, is illustrated in Table 2. Table 2 illustrates a social media dimension data, analyzed for sentiments.

TABLE 2

| Initial Social Media sentence data extract from | Enriched data that may be included into |
|---|---|
| JSON generated from Primary Search | original JSON |
| Hey James. May I have some opinion about | { |
| Chocolate Factory X? they are very good. | “document_tone”: { |
| They run a fun tour for chocolate making and | “tones”: [ |
| tasting, and offer a variety of different flavored | { |
| chocolates for tasting. I enjoyed the chocolate | “score”: 0.798719, |
| tasting especially. I will bring my friends the | “tone_id”: “satisfaction”, |
| next time. | “tone_name”: “Satisfaction” |
| | }, |
| | { |
| | “score”: 0.38081, |
| | “tone_id”: “analytical”, |
| | “tone_name”: “Analytical” |
| | }, |
| | { |
| | “score”: 0.530625, |
| | “tone_id”: “tentative”, |
| | “tone_name”: “Tentative” |
| | } |
| | ] |
| | }, |
| | “sentiment”: { |
| | “document”: { |
| | “score”: 0.811656, |
| | “label”: “positive” |
| | } |
| | } |

In some embodiments, cognitive models may be trained based on the following input features: product; brand (which may be optional); location; target consumer class using market segmentation approach; sentiment measure of economy news (e.g., considering a number of (e.g., 10) top hits); sentiment measure of politic news (e.g., considering a number of (e.g., 10) top hits); weather information; the average of unit cost of the product that is purchased from the supplier. In some embodiments, the top hits for economy news and politic news may have been previously classified in other models by source of information importance factors that are derived from a knowledge base, and sentiment and tone, which may be derived from an enrichment phase of top hits information. In some embodiments, one or more of, or one or more combinations of, or all of the above input features may be used to train the cognitive models.

In some embodiments, a machine learning algorithm that trains the cognitive models, may include neural networks, and for example, a training algorithm may include training neural networks using a back propagation technique. In some embodiments, several classes may represent several dimensions. In some embodiments, one or more cost functions may be implemented for the neural networks, for example, like those for linear regression and logistic regression. In some embodiments, cost functions may consider K classes for each training instance 1 to m, as described in the following formula as an example, where x represents input feature vector values, h_{θ}(x⁽ⁱ⁾) represents estimated output value associated with input x⁽ⁱ⁾, and y⁽ⁱ⁾ represents ground truth value associated with input x⁽ⁱ⁾:

$$J ( θ ) = \frac{1}{m} {\sum }_{i = 1}^{m} {\sum }_{k = 1}^{K} ( - {y}_{k}^{( i )} log {{h}_{θ} ( {x}^{( i )} )}_{k} - ( 1 - {y}_{k}^{( i )} ) log ( 1 - {{h}_{θ} ( {x}^{( i )} )}_{k} ) )$$

with K classes: sum cost of K classes for each training instance. In the above formula, minimizing the cost function (J(θ)) finds optimal parameters (θ) for the models.

In some embodiments, output features of the models may include the suggested amount to buy, the suggested price, and a score of this response.

For instance, at 214, executing the trained models 210 trained by one or more machine learning algorithms using training or sample data from a knowledge base 212, generates hypotheses and evidence scores. In some embodiments, for each data dimension, each hypothesis type has an evidence scoring, for example, output by each trained model at 210. An output of a cognitive model may include hypotheses on a dimension (e.g., also referred to as a class), for instance, as shown at 208. Each of cognitive models 210 in different dimensions may produce output hypotheses associated with that different dimension. The hypotheses and evidence scoring at 214 includes consolidating the hypotheses of different dimensions, and scoring this consolidated response. An outcome of a cognitive model 210 may provide such consolidated hypotheses and score.

At 216, a synthesis phase collects each dimension data results to deliver to the confidence merging and ranking phase at 218. At 220, an answer and confidence result generated at 218 may be presented to the end user, e.g., with a reason to buy or stock a perishable product with evidence that supports the hypotheses and the amount or quantity to purchase.

In some embodiments, the synthesis phase is used to consolidate multiple consolidated answers for a same input type. For instance, considering the data collected from a product X, location Y, target class Z, Weather W influence weight, Political sentiment P, Economic Sentiment E, Social media opinion S and current amount in stock C. An instance of data gathered from data engineering and inputting the data into an artificial intelligence (AI) model may produce an outcome that specifies an amount of 30 units of product X. Consider a following simple linear regression, which produces a continuous value in output: y˜b0+b1*X+b2*Y+b3*Z+b4*W+b5*P+b6*E+b7*S+b8*C, where b0 represents the bias, and b1 to b8 represent the slopes (parameters).

Suppose such a model in training and test phases, based on data collected from external sources, generates two final values, 35 units of product X and 50 units for product X, for the same conditions. The synthesis process may calculate what is most correct to show and the information that supports the final hypotheses based on a fact that there may be multiple candidate answers. A dimension consolidation in some embodiment may be performed in a pre-processing step before sending data to an artificial intelligence model to calculate an amount to buy.

In some embodiments, at 222, the end user may be allowed to score each result, for example, via a user interface. The user's feedback 222 on the result 220 may be stored in a database 224 (e.g., historical results feedback database). Such retro feedback information stored in the database 224 may be used as further training data to retrain the cognitive models 210, for example, for improved training on cognitive model that refines the system confidence.

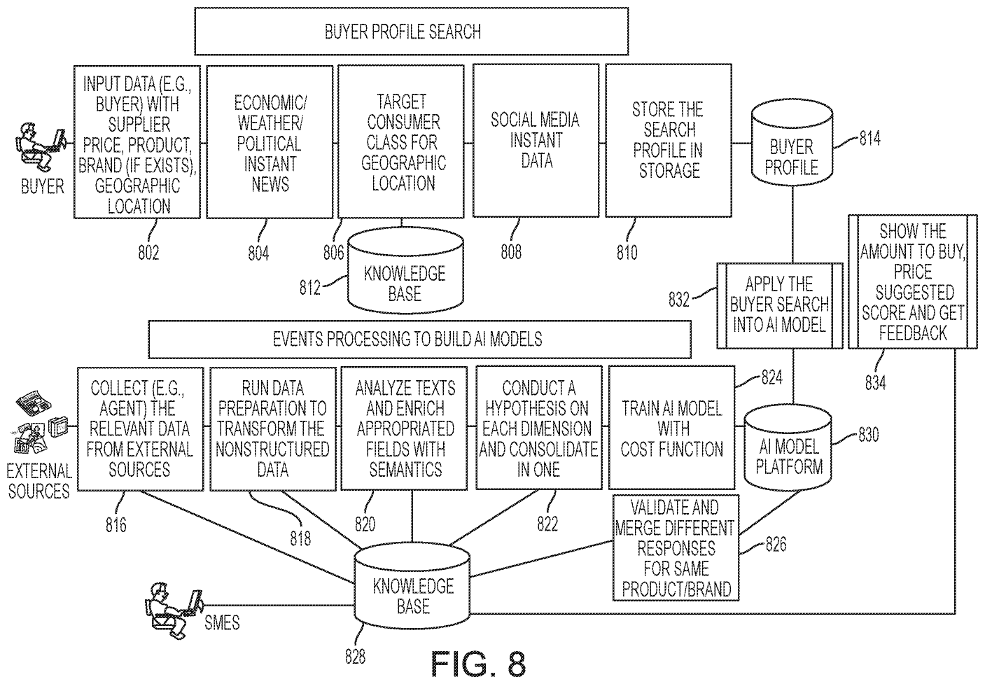

FIG. 8 illustrates workflows of methods in one embodiment. A workflow shown at 802-814 illustrate a scenario, in which a user provides an input (e.g., question with respect to a product and/or brand), and a method in one embodiment searches data sources and collects data such as weather data, current political information, economic data, target consumer class (e.g., related by region (e.g., region Y provided by user), and any social media data (e.g., of current time or a define time period). For instance, at 802, a user may input, and a method in some embodiments receive, input data such as a supplier price, product, brand (e.g., if available), and geographic location. In some embodiments, geographic location may be automatically determined. At 804, data sources may be searched for data associated with economic, weather, policy, or like information or news. At 806, data sources may be searched for data associated with target consumer class in the geographic location. At 808, data sources may be searched for data associated with social media data, for example, current social media data, from online social media or network application platforms. A method may include storing at 810, such information or data as user search profile in a storage device (e.g., as a database or another data form) 814.

Another workflow shown at 816-830 represent a process of building or generating an artificial intelligence (AI) model (or models) in one embodiment. For instance, the processing shown at 816-830 may be performed at components 202-220 shown in FIG. 2. At 816, a method may include collecting data from external sources. An agent or an automated agent may perform collecting of such data. Data preparation may be performed at 818, for example, data reduction, cleanup, normalization, and/or other data preparation may be performed. Unstructured data may be transformed to structured data. At 820, data may be enriched. This processing may represent a data engineering phase, for example, in which data may be enriched, for example, with semantics. The processing shown at 816, 818 and 820 may be performed at the component 204 shown in FIG. 2.

At 822, hypotheses for each dimension (e.g., social, political, economic, and/or another dimension) may be generated for a product and/or brand gathered from an external source. Hypotheses of each dimension may be consolidated into one hypothesis for a specific set of data (e.g., product/brand data). An AI model (e.g., shown at 210 in FIG. 2) may perform this dimensional reduction in some embodiments. The processing at 822 may involve components shown at 208, 210, and 214 in FIG. 2.

At 824, an AI model may be trained to predict an amount for purchase and a price suggestion for a product and/or brand. The processing at 824 may involve a model trained in component 210 in FIG. 2. The model may be trained in the background, for example, as a background workflow or process.

A processing at 826 may include validating and merging different responses, which may be generated, for the same product and/or brand. For instance, for a product X on geographic location Y based on inputs, there may be more than suggestions for purchase amount and price. The processing at 826 may merge a number of (e.g., n) responses that are similar in suggestion and may order the responses by their scores. The processing at 826 may involve components 216 and 218 shown in FIG. 2.

Processing at 832 and 834 represent running an already trained model, for example, responsive to receiving a new data from a user search, for instance, shown at 802-814. At 832, AI model is run with results of a search, for instance, at least some of the results transformed into feature vectors and the feature vectors input into the AI model. The processing at 832 may involve a component shown at 218 in FIG. 2. At 834, the outcome (e.g., output) of the AI model may be presented to a user, and user feedback may be received. The processing at 834 may involve components shown at 220, 222 and 224 in FIG. 2. For instance, an answer with a score may be presented, and a user's validation of the answer (e.g., result), for instance, with user feedback, may be received. User feedback may include replying to a survey or the like, and may include user's opinion as to an effectiveness of the suggestion provided to the user. Such feedback may be saved or stored in a storage device, for example, for continuous learning, retraining, refining or retuning of the AI model.

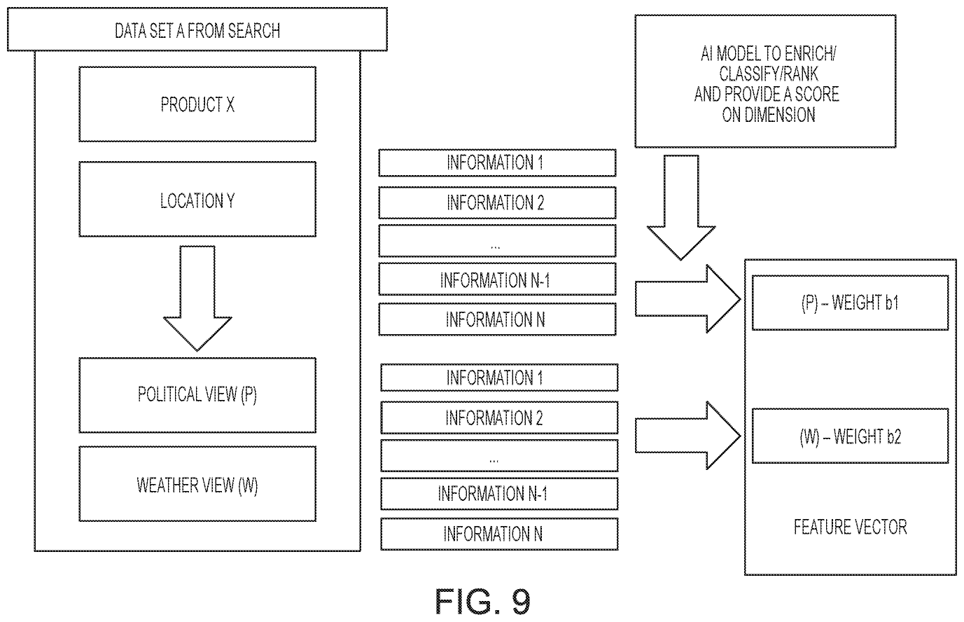

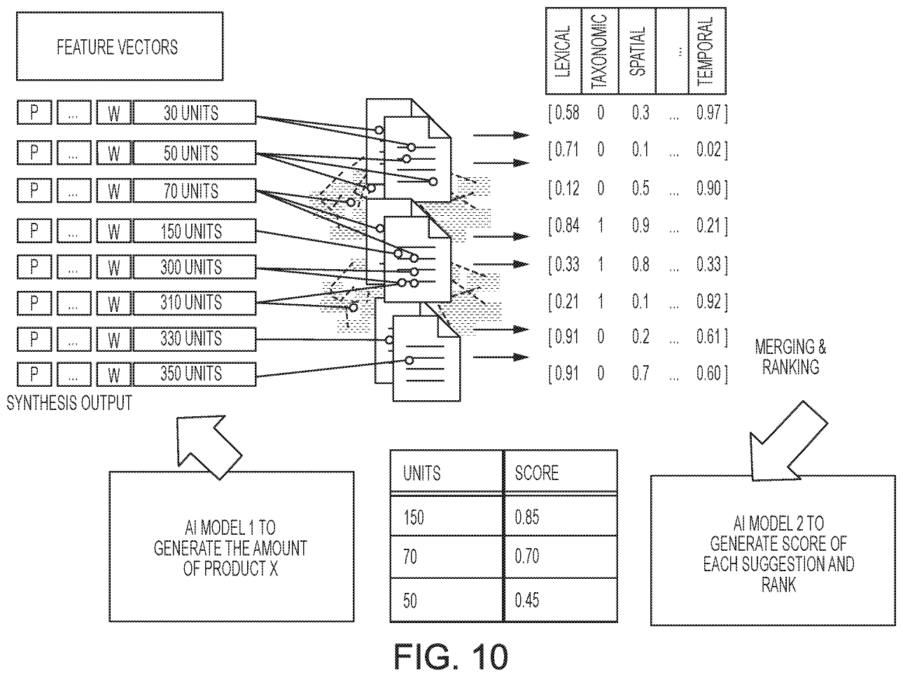

FIG. 9 illustrates an example of performing a synthesis, for example, shown at 216 in FIG. 2, in one embodiment. Referring to FIG. 9, a synthesis component (e.g., shown in 218 in FIG. 2) may select the best score on each dimension related to a dataset, for example, a dataset A collected from a search (e.g., search performed at 204 in FIG. 2). An AI model on each dimension may classify the information unit. A synthesis processing may perform an analysis to generate a one feature vector for the data set. There may be multiple data sets, and by consequence, multiple feature vectors. The component at 218 in FIG. 2 may receive those vectors and provide a score on each of those feature vectors and rank feature vector possibilities, for example, as illustrated on FIG. 10.

FIG. 10 illustrates feature vector merging and ranking in one embodiment. In some embodiments, a synthesis component may deliver a number of feature vectors, for example, each feature vector generated based on a different data set. Each feature vector may have been consolidated across multiple dimensions in a synthesis phase, for example, shown in FIG. 9, for example, by running an AI model (e.g., referred to as AI model 1 in FIG. 10). In some embodiments, another AI model (e.g., referred to as AI model 2 in FIG. 10) may score each response associated with a feature vector, may rank the feature vectors according to their scores, and present the response with ranked feature vectors, for example, to a user.

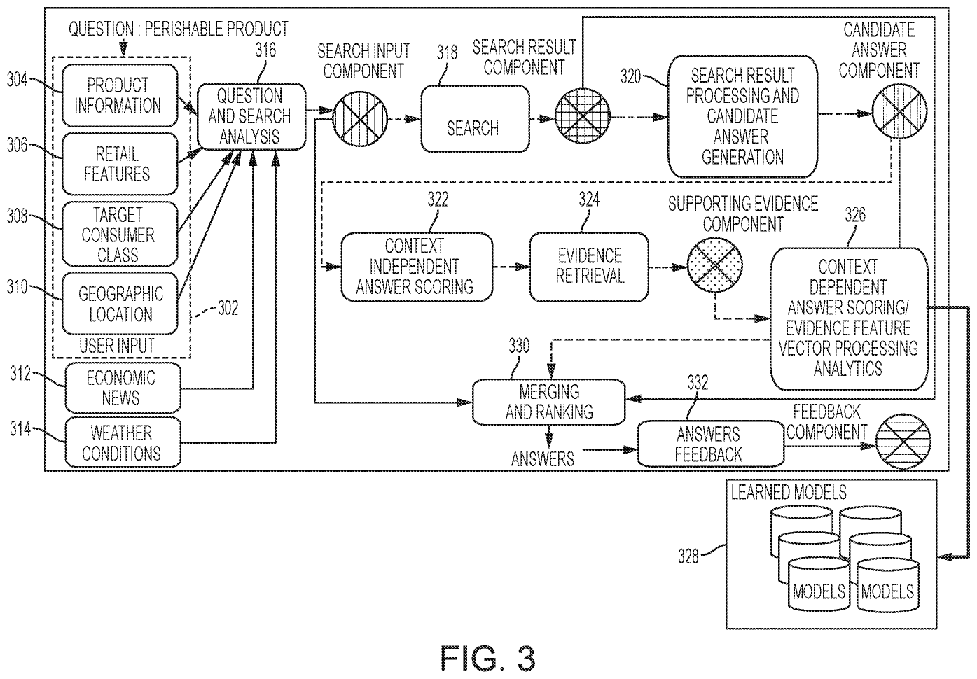

FIG. 3 is a diagram illustrating a data workflow in a method of the present disclosure according to one embodiment. As an example, FIG. 3 explains a data workflow starting with the user input until the final response and feedback. The method may be executed on or by at least one hardware processor, for instance, couple with a memory device, and for example, running a user interface that interacts with a user, for example, on a display screen. For instance, the hardware processor executing the method may receive a question or user input 302, for example, from a user, which question or user input 302 may be entered via the user interface. In another aspect, the user input 302 may be received as an input file or data. User input 302 may include product information 304, retailer features 306, target consumer class 308 and geographic location 310. Product information 304 may include user input details about a product such as the product segment or brand, the current amount or quantity of stock the user has, and brand or segment the user desires to buy. Retail features 306 may contain data such as the average profit in a period (e.g., in monthly basis) and the size of the retailer based on a standard industry classification. The target consumer class 308 may contain data such as a specific group of consumers for which the product is targeted. Such information may be captured from a knowledgebase or input by a user. The geographic location 310 may contain information such as the location or region where the product will be sold. This data flow may apply to two workflows, for example, for obtaining data periodically to train a model, and also when a user inputs data to be predicted by a trained model.

In addition to the user input 302, the method may also include receiving or determining economic news 312, which may include, for example, data related to the product segment selected or input by a user and which news database should be used to crawl or search for information, which may be gathered from a knowledgebase. The knowledge base may include a database maintained by subject matter experts. This database may accept inputs such as what economic, political, weather sites to crawl on a regular or periodic basis to train a model and annotations that can be improved on a regular or periodic basis, which may be used in a primary search to find relevant information on the dimensions (e.g., politic, weather, economic).

Further, information about weather conditions 314 in the geographic location may be gathered or received. Weather conditions 314 allow for inferring information such as whether some products are consumable or obtainable. For instance, if there is a very cold weather prediction (e.g., in few weeks), some products may be less consumable than others.

A question and search analysis component 316 builds a search strategy based on the user input. For instance, the search strategy constructs what search to perform on which sites or sources, for example, on different dimensions such as economic news, geographic location (geolocation), target class, and/or others. The output of the question and search analysis is used as an input to a primary search component 318. For instance, a user input or question may be parsed using techniques such as a natural language processing. As an example, parameters in a natural language conversation may be extracted to build a search strategy. In addition, parameters such as geographic location and consumer class may be added to the search strategy. Other parameters to search in different dimensions may be added to the search strategy.

The primary search component 318 crawls against unstructured content from sources such as the public web sites and/or another data source, defined or generated by the question and search analysis component 316. The primary search component 318 outputs the results of the search produced by the crawling.

A search results and candidate answers generation component 320 filters possible answers and builds a candidate answer component, for example, based on passage score on text and title appearing on a web page returned by the primary search component. Candidate answers are also referred to as hypotheses. A candidate answer is referred to as a hypothesis. For instance, candidate answers generation component 320 may generate candidate answer for a specific dimension. For instance, consider that on social media, the primary search gathered information about Product X of Brand Y. Some of the information may be irrelevant on that specific dimension. In some embodiments, information on a dimension may be ranked by a score, and those not meeting a predefined threshold level may be filtered out. Conversely, those meeting the predefined threshold level may be selected as candidate answers. Consider another example in which the primary search extracts or obtains information about Product Z of Brand Y, which is unrelated to Product X. The component 320 may classify this information with low score or ranking, and thus this information may be discarded and not used as a candidate answer on the dimension.

A content independent answer scoring component 322 defines an independent score for each candidate answer with respect to a dimension. A context or content independent score refers to a score on each dimension. This component 322 may measure an importance of a passage or title-oriented document on a dimension. For example, there may be multiple documents with evidences in passages or title that inform opinions about Product X or Brand Y in an economic dimension. Those passages may be considered as candidates, which may be scored on relevance. This type of score includes a context independent score. A subsequent processing in a synthesis component may reduce the dimension to an entry, which may be represented as a feature vector.

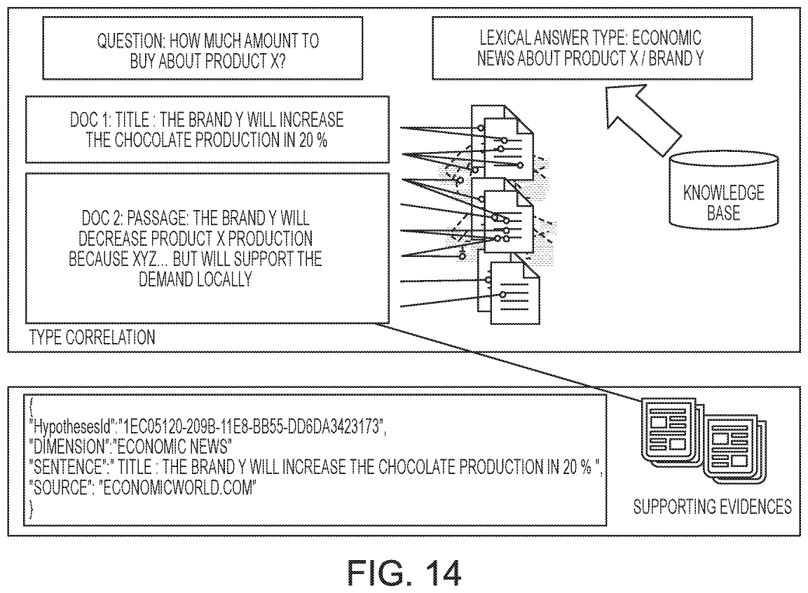

An evidence retrieval component 324 collects evidence from the candidate answer, for each candidate answer, generating a supporting evidence component associated with each candidate answer (hypothesis). The evidence retrieval component 324 may use a relationship extraction machine learning mechanism to build the supporting evidence, and generate a component (supporting evidence component) with all previous section content and the generated supporting evidences. Evidence may be collected as part of a primary search phase and refined, for example, in merging and rank phases, where the evidences are filtered, merged (e.g., if there are similar hypothesis), and/or diffused (e.g., if evidences are similar). A relationship extraction machine learning mechanism may include a concept of type correlation, including a correlation between a question, a lexical answer type (the desired response) and a document evidence that supports the response. For example, consider information about chocolate boxes of product X. Based on a question from a user about Product X, a lexical answer type on dimension economic may include news about product X in an economic dimension. The supporting evidences may include searches of unstructured documents about product X, or Brand Y (e.g., if product X belongs to Brand Y), e.g., based on information contained in a knowledge base. In some embodiments, evidences obtained on a primary search may be retained and selected in next phases of processing. FIG. 14 illustrates relationship extraction in one embodiment.

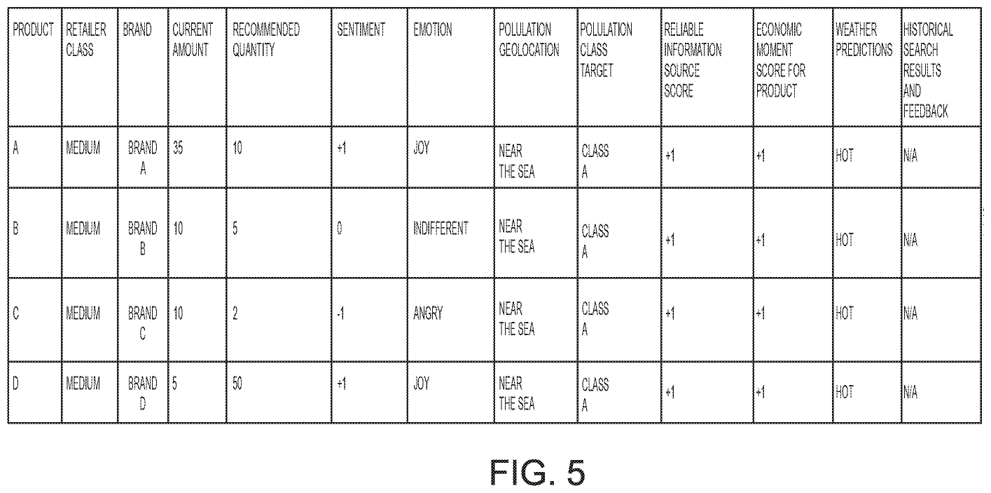

A content dependent answer scoring component 326 defines an answer dependent scoring and builds an evidence feature vector. The feature vector built is used to place or assign weights on each dimension, for example, as described with reference to an example shown in FIG. 5. FIG. 5 shows an example of evidence feature vector in one embodiment. Each feature of the solution places a weight, and based on an algorithm such as a logistic regression, the content dependent answer scoring component 326 computes a recommended quantity to buy or stock. As an example, each line of a result set shown in FIG. 5 represents an example feature vector generated in a synthesis component (e.g., FIG. 2 at 216). In FIG. 3, a relationship is represented by the component at 326, which provides the data (feature vector) to artificial intelligence models to generate outcomes, e.g., an amount to buy, and a score of each feature vector.

A merging and ranking component 330 (also referred to as a “final” merging and ranking) may execute, based on the feature vector, a result calculation or computation. The result shows the answer and confidence, suggesting the quantity to buy for the product brand or product segment and the evidence that support the hypotheses. For example, a computation scores each feature vector and ranks the feature vectors.

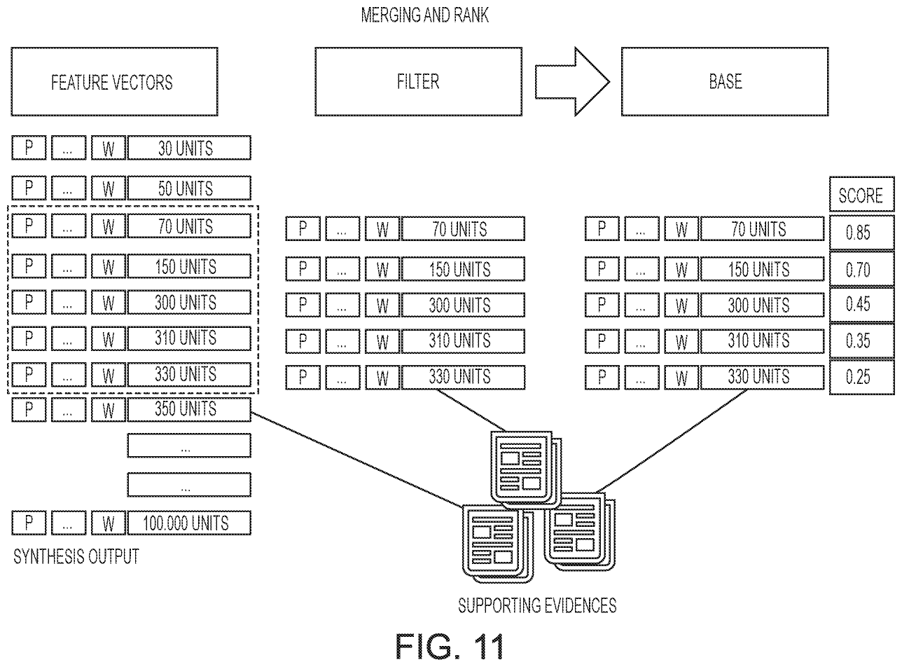

The merging and ranking of the suggested amount for replenishment (e.g., amount to buy or stock) may include the following steps: Filter; Base; Merge; Evidence diffusion; and Elite. The filter step may use light-weight features to select hypotheses for deeper analysis. The base step may include initially ranking the amounts suggested for replenishment and evaluating confidences values. The merge step may include merging equivalent hypotheses. The evidence diffusion step may include merging support to hypotheses. The elite step include performing successive refinements to upper bound the responses, for example, select top 5 responses responsive to finding multiple answers. Generally, filtering may discard outliers, for example, based on historical data. FIGS. 11-13 illustrate merging and ranking with respect to an example, in one embodiment. Referring to FIG. 11, as an example, the figure illustrates amounts of chocolate boxes. A filter may select values based on historical data that meet a threshold (e.g., within a curve) and a base method assigns a score to each of the selected response from the filter phase.

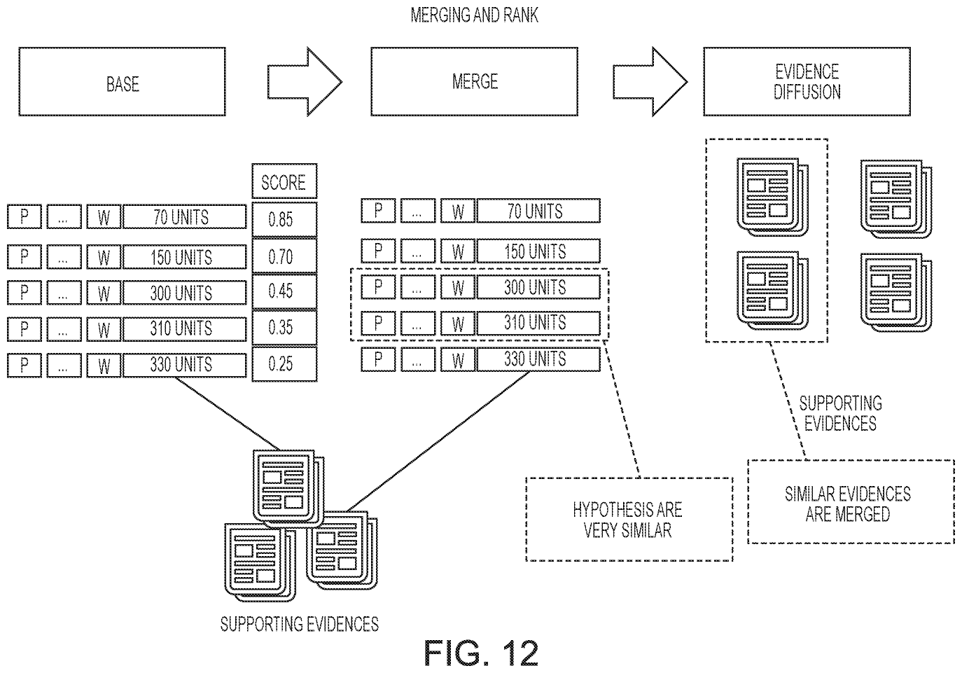

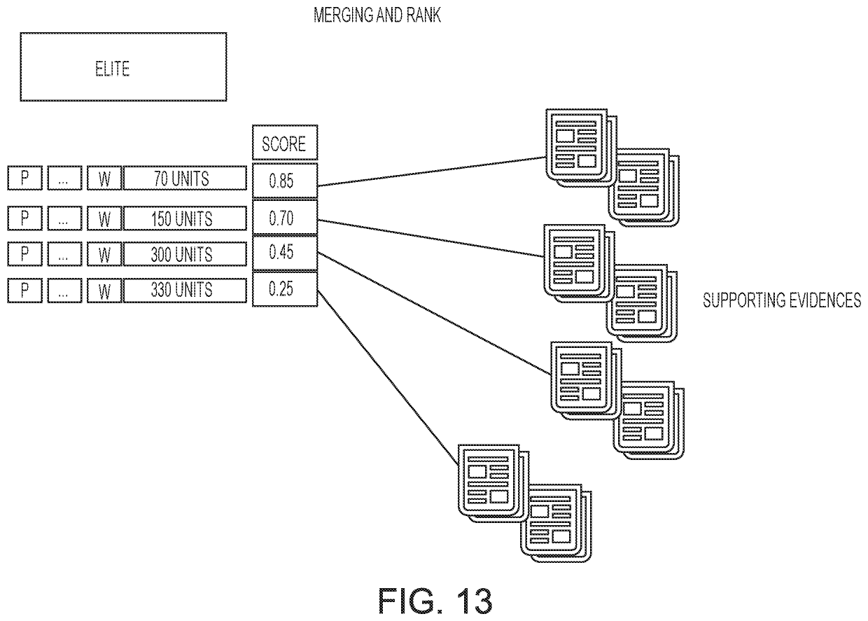

FIG. 12 illustrates an example of merging similar hypothesis. For instance, consider an example, in which two evidences from two different sources in a search include unstructured data, e.g., natural language sentences referring to similar content. The two evidences may be merged. An elite phase, for example, shown in FIG. 13, may rank based on one or more criteria, a number of scored hypothesis and group the similar evidences that support the hypothesis.

An answers feedback component 332 may receive user feedback and store the feedback in a database. For instance, the user may provide a feedback on the suggested quantity to buy and the supporting evidence. The saved or stored user feedback may be used to retrain the cognitive model on each dimension 328, for example, to improve the accuracy of method.

In some aspects, the method of the present disclosure may search and use unstructured data, for example, from web sites, and for example, dimensions of data domain such as economic news, geographic behavior, social media platform/application, and weather data, which may be outside of a particular supply-chain enterprise. In some aspects, the method of the present disclosure builds cognitive learning models based on such unstructured data. So for example, the method in some embodiments takes into its decision making factor other data not directly related to supply chain such as customer opinion of a product such as sentiment, emotions, weather factors that affect consumption of a specific product, and economic news that can impact the decision making.

The system and/or method according to some embodiments may provide context dependent answering scoring and evidence featuring vector processing. Such processing may include a semantic integration of user input features like product information, retail features, target consumer class, geographic location and unstructured information collected from web site sources such as economic news and weather conditions, based on weights associated with each unstructured data dimension, for example, created in a primary search.

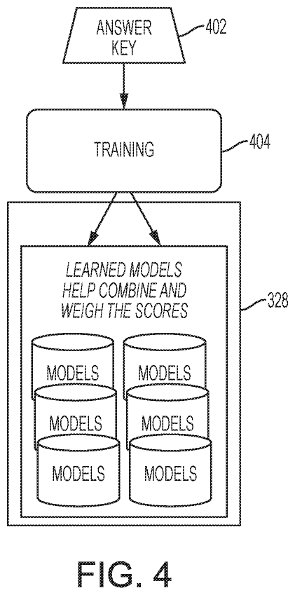

FIG. 4 is a diagram illustrating trained models according to an embodiment. In some embodiments, a feature vector includes an n-dimensional vector of features that represent an object, e.g., a product. In some embodiments, a set of models for supported perishable products is trained using machine deep learning models using statistical and rule-based classifiers defined by experts. The set of models predicts the amount or the quantity of product to replenish. In some embodiments, the models are trained per dimension, and the number of models trained may depend on the number of data dimensions available, for example, results of a primary search which obtains structured and unstructured data, for example, directly related by keywords, by ontology and/or by an annotation system.

A set of models may be trained based on a training data set containing a number of questions and corresponding answers 402 related to a product replenishment considering multiple factors or features like target consumer class, geographic location, retail features, product information, economic news and weather information. In some aspects, answers to questions in the training data may include fuzzy logic where 0 is not to by a product and more than 0 means to buy some product amount. In some aspects, the evidence of support may be based on historical facts and also dynamic information such as the economic news and weather conditions that change over time.

A machine learning algorithm such as a deep learning algorithm may be implemented to perform training at 404. Training at 404 trains and produces machine learning models 328, for example, deep learning models with multiple hidden layers with learned weights associated with nodes of the hidden layers. Machine learning algorithm's hyperparameters associated with the deep learning models may be configurable. A deep learning model may be formed by multiple models, one per dimension, and one model may output a final score.

In some aspects, each product type may have a different training set. Also, a solution can have more than one answer. For the solution that may have more than one answer, the system and/or method in some embodiments may implement a ranking mechanism based on confidence values, for example, produced by one or more statistical and rule-based classifiers.

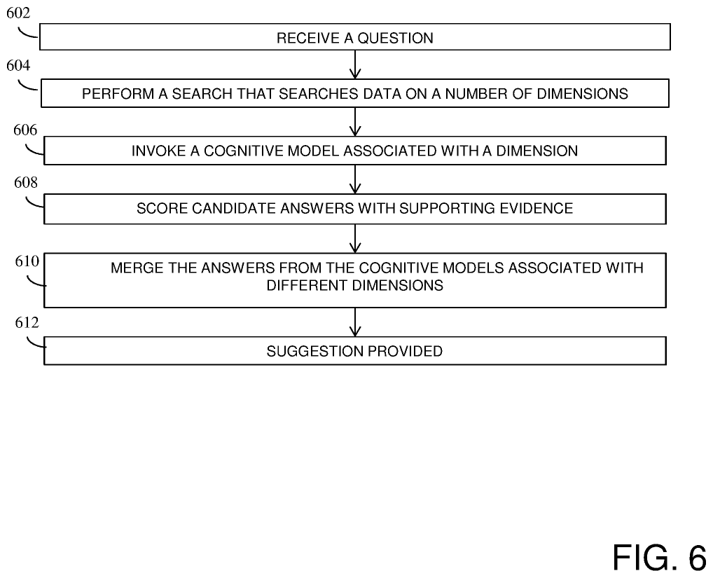

FIG. 6 is a flow diagram illustrating a computer-implemented process that predicts perishable food stock quantity for replenishment, in one embodiment. One or more processors, for example, of a circuit or circuitry, may perform the method. A processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium. The one or more hardware processors may be coupled with interface devices such as a network interface for communicating with remote systems, for example, via a network, and an input/output interface for communicating with input and/or output devices such as a keyboard, mouse, display, and/or others. In some aspects, code implementing one or more functionalities of a method and/or a system of the disclosure can be written in programming languages such as Python from Python Software Foundation, R, Scala, and Go from GOOGLE, but not limited to only those languages.

At 602, a question may be received, and in response to a question about a perishable product for which a user expects an advice, the method may include performing at 604, a primary search that searches data on a number of dimensions including product information, retail features, target consumer class, geographic location, economic news and weather forecasts, to generate hypotheses or candidate answers based on web and social media data sources. For instance, a search strategy may be generated using a selected search type from a set of search types specific to each dimension to form a search input component. The generated search strategy may be used to crawl against unstructured content, for example, from public web sites and other sources to create output as a search result component.

At 606, a cognitive model, which is trained and associated with a dimension may be invoked. In some embodiments, a cognitive model is built for each dimension of multiple dimensions. Thus, multiple cognitive models may be built. A cognitive model includes feature vectors with assigned weights. Based on user input vectors, and other operations variables, such as weather, economics information, location, social class, and/or others, the cognitive models may treat all information to output a classification or an answer comprising the quantity to purchase. In some embodiments, each of the cognitive models in different dimensions is invoked. The input data to the cognitive model, in some embodiments, may use a result of the primary search to train the models. Examples of input data may include: product, brand (optional), location, target consume class using market segmentation approach, sentiment measure of economic news (e.g., a top number (e.g., 10) of hits), sentiment measure of political news (e.g., a top number (e.g., 10) of hits), weather news, and an average unit cost of the product that is purchased from a supplier.

At 608, the candidate answers may be scored (e.g., at 210 in FIG. 2) and supporting evidence associated with the scored candidate answers may be selected (e.g., from 214 in FIG. 2). At 610, the answers from the cognitive models associated with different dimensions may be merged. At 612, suggestion is provided.

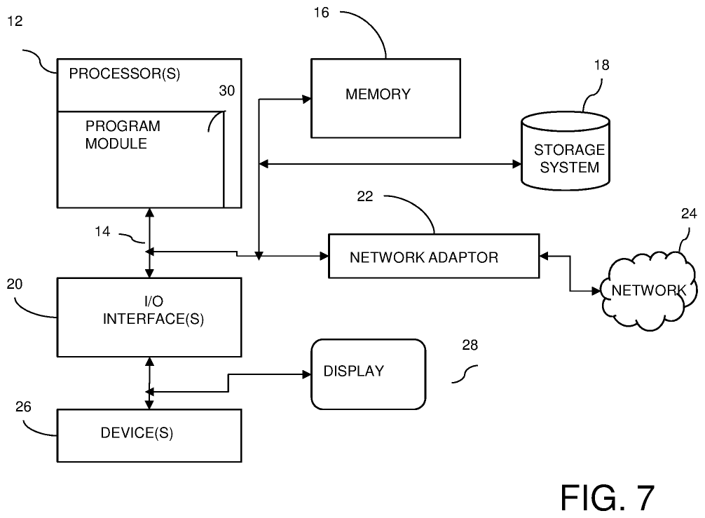

FIG. 7 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A computer-implemented method of predicting perishable food stock quantity for replenishment, the method executed by at least one hardware processor communicatively coupled to a network of computers, comprising:
receiving a user input comprising at least a product identifier of a product about which a quantity to replenish is to be predicted;
creating a search strategy comprising searching at least unstructured multiple dimensions of data stored on the network of computers based on the user input;
performing a search of the network of computers according to the search strategy;
invoking a machine learning model associated with a dimension, for each of the multiple dimensions, with a result of the search generated into a feature vector as input to the machine learning model, the machine learning model outputting a replenishment quantity along each of the multiple dimensions, the output of the machine learning model representing candidate answers;
selecting supporting evidence associated with the candidate answers;
merging the candidate answers of the multiple dimensions; and
providing a result of the merged output quantities as a predicted suggestion.

2. The method of claim 1, wherein the multiple dimensions comprises product information, retail features, target consumer class, geographic location, economic news and weather forecasts.

3. The method of claim 1, further comprising scoring the candidate answers.

4. The method of claim 1, further comprising training the machine learning model to predict the replenishment quantity.

5. The method of claim 2, wherein the machine learning model is trained to predict the replenishment quantity separately along each of the multiple dimensions.

6. The method of claim 1, further comprising receiving user feedback associated with the predicted suggestion and retraining the machine learning model based on the user feedback.

7. A computer readable storage medium storing a program of instructions executable by a machine to perform a method of predicting perishable food stock quantity for replenishment, the method comprising:
receiving a user input comprising at least a product identifier of a product about which a quantity to replenish is to be predicted;
creating a search strategy comprising searching at least unstructured multiple dimensions of data stored on the network of computers based on the user input;
performing a search of the network of computers according to the search strategy;
invoking a machine learning model associated with a dimension, for each of the multiple dimensions, with a result of the search generated into a feature vector as input to the machine learning model, the machine learning model outputting a replenishment quantity along each of the multiple dimensions, the output of the machine learning model representing candidate answers;
selecting supporting evidence associated with the candidate answers;
merging the candidate answers of the multiple dimensions; and
providing a result of the merged output quantities as a predicted suggestion.

8. The computer readable storage medium of claim 7, wherein the multiple dimensions comprises product information, retail features, target consumer class, geographic location, economic news and weather forecasts.

9. The computer readable storage medium of claim 7, further comprising scoring the candidate answers.

10. The computer readable storage medium of claim 7, further comprising training the machine learning model to predict the replenishment quantity.

11. The computer readable storage medium of claim 8, wherein the machine learning model is trained to predict the replenishment quantity separately along each of the multiple dimensions.

12. The computer readable storage medium of claim 7, further comprising receiving user feedback associated with the predicted suggestion and retraining the machine learning model based on the user feedback.

13. A system of predicting perishable food stock quantity for replenishment, comprising:
at least one hardware processor communicatively coupled to a network of computers, the at least one hardware processor operable to perform at least:
receiving a user input comprising at least a product identifier of a product about which a quantity to replenish is to be predicted;
creating a search strategy comprising searching at least unstructured multiple dimensions of data stored on the network of computers based on the user input;
performing a search of the network of computers according to the search strategy;
invoking a machine learning model associated with a dimension, for each of the multiple dimensions, with a result of the search generated into a feature vector as input to the machine learning model, the machine learning model outputting a replenishment quantity along each of the multiple dimensions, the output of the machine learning model representing candidate answers;
selecting supporting evidence associated with the candidate answers;
merging the candidate answers of the multiple dimensions; and
providing a result of the merged output quantities as a predicted suggestion.

14. The system of claim 13, wherein the multiple dimensions comprises product information, retail features, target consumer class, geographic location, economic news and weather forecasts.

15. The system of claim 13, wherein the at least one hardware processor is further operable to score the candidate answers.

16. The system of claim 13, wherein the at least one hardware processor is further operable to train the machine learning model to predict the replenishment quantity.

17. The system of claim 14, wherein the at least one hardware processor is further operable to train the machine learning model to predict the replenishment quantity separately along each of the multiple dimensions.

18. The system of claim 13, wherein the at least one hardware processor is further operable to receive user feedback associated with the predicted suggestion and retrain the machine learning model based on the user feedback.
